(19) United States
(12) Patent Application Publication
(10) Pub. No.: US 2001/0048452 A1
(43) Pub. Date: Dec. 6, 2001

(54) METHOD FOR MANUFACTURING HIGH-DENSITY INK-JET PRINT HEAD

(76) Inventors: YUAN-LIANG LAN, HSINCHU HSIEN (TW); YI-YUNG WU, HSINCHU HSIEN (TW); CHIEH-WEN WANG, HSINCHU CITY (TW); MING-LING LEE, HSINCH CITY (TW); YI-HSUAN LAI, HSINCHU CITY (TW)

Correspondence Address: J.C Patents INC, 4 Venture, Suite 250, IRVINE, CA, 92618, US

(21) Appl. No.: 09/059,309

(22) Filed: Apr. 13, 1998

(30) Foreign Application Priority Data
Feb. 5, 1998 (TW) 87101487

(51) Int. Cl. B41J 2/145; H04R 17/00

(52) U.S. Cl. 347/42; 347/40; 29/890.1; 29/25.35

(57) ABSTRACT

A method for fabricating a high-density ink-jet print head that utilizes a common high-density nozzle plate as a base for aligning a multiple of ink-jet printing modules. The high-density nozzle plate has wide body, high-density, high-resolution nozzles. The nozzle plate is fabricated using conventional electrochemical machining or laser machining techniques. The nozzle plate is able to provide not only a base for aligning each ink-jet printing module, but also the alignment necessary for the whole group of the ink-jet printing modules so that all modules are aligned properly. Therefore, the alignment operation can be carried out without the need for sophisticated alignment equipment and the alignment accuracy is high. Consequently, the production cost of a high-density, wide body, ink-jet print head is lowered, and the product yield of the print heads is increased

### CROSS-REFERENCE TO RELATED APPLICATION

This application claims the priority benefit of Taiwan application serial no. 87101487, filed Feb 5, 1998, the full disclosure of which is incorporated herein by reference.

### BACKGROUND OF THE INVENTION

Field of Invention

The present invention relates an ink-jet device having a multiple print heads and a multiple nozzle plate. Particularly, the present invention relates to a high-density ink-jet printing device.

Description of Related Art

Inkjet printing techniques are now widely used in computer peripheral products such as printing machines, fax machines and drawing machines. In order to increase printing speed, a method relying on increasing the operating frequency of the ink-jet has been suggested. However, this method can lead to the generation of too much heat in the print-head resistor or other related energy transducer elements as well as over-drive problems. This will result in general instability of the ink jet and subsequently lead to poor printing quality.

Another method to increase the printing speed of an ink-jet print head is to design a multiple-nozzle, wide bode, ink-jet print head. For example, in U.S. Pat. No. 5,016,023 titled, “Large Expandable Array Thermal Ink Jet Pen and Method of Manufacturing”, a modular package density has been suggested, where a plurality of ink-jet print-head modules are assembled together forming one giant ink-jet print-head. However, for this type of print-head design, the nozzle plate of each ink-jet print-head module must first be carefully aligned and packaged. Subsequently, alignment and assembling process is carried out to combine each print-head module into one large print-head unit. Consequently, a large number of steps are required and highly sophisticated alignment equipment is needed to position the print head. This not only will increase production cost, but will also leave the fabrication process difficult to control.

In light of the foregoing, there is a need to improve the ink-jet print-head design so that a faster printings speed can be achieved without causing many manufacturing problems.

### SUMMARY OF THE INVENTION

Accordingly, the present invention is to provide a method for fabricating a wide body, high-density ink-jet print head that uses a common nozzle plate as a base for aligning various ink-jet printing modules. Hence, the requirement for precise packaging alignment and positioning accuracy is effectively reduced, and the production cost can be lowered while the print quality can be increased.

To achieve these and other advantages and in accordance with the purpose of the invention, as embodied and broadly described herein, the invention provides a method for fabricating a high-density ink-jet print head. The method comprises the steps of first providing a nozzle plate that contains a plurality of multiple-nozzle outlets. Then, one ink-jet printing module is aligned and then attached to each multiple-nozzle outlet on the nozzle plate. Next, the electrical outlets of each ink-jet printing module are bonded and connected to its corresponding signal receiving points. Finally, the aligned, attached and bonded assembly containing a plurality of ink-jet printing modules is mounted onto a supporting base.

In another aspect, this invention provides a high-density ink-jet print-head device comprising a nozzle plate having a plurality of multiple-nozzle outlets; a plurality of ink jet printing modules respectively aligned and attached to each multiple-nozzle outlet of the nozzle plate, and groups of conductive wires for bonding to signal-receiving points and corresponding ink jet printing module. The nozzle plate can be made from metal and fabricated by electrochemical machining, or alternatively, the nozzle plate can be made from plastic and fabricated by laser machining. The ink-jet can be driven by ink-jet printing modules employing either a thermal bubble mechanism or a piezoelectric mechanism.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view shorting the components of a high-density ink-jet print head assembly according to the embodiment of this invention, and

FIG. 2 is a block diagram showing the manufacturing steps in fabricating a high-density ink-jet print head according to the embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

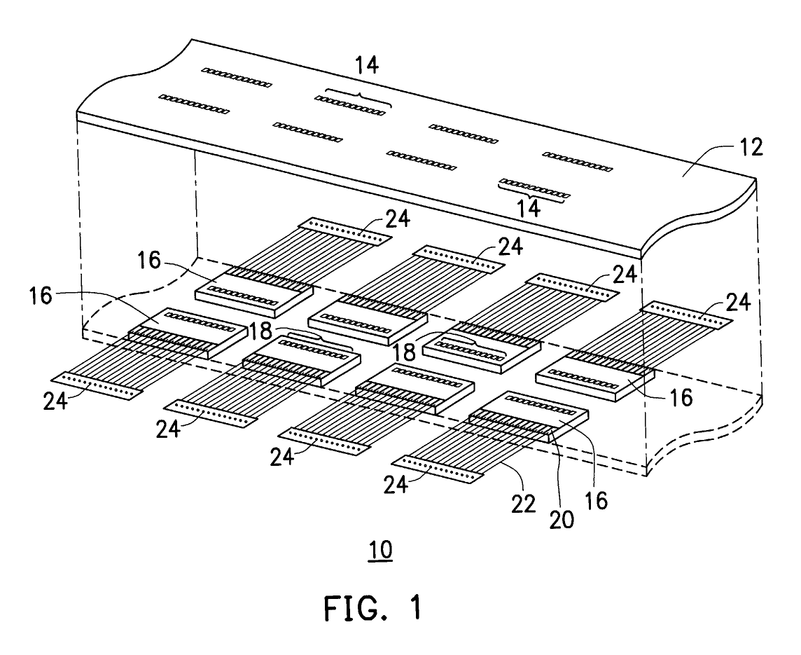

FIG. 1 is a perspective view showing the components of a high-density ink-jet print head assembly according to the embodiment of this invention. As shown in FIG. 1 the high-density ink-jet print-head assembly 10 comprises a nozzle plate 12 having a plurality of multiple-nozzle outlets 14 formed thereon and a plurality of ink-jet printing modules 16. For example, there are altogether two columns of eight multiple-nozzle outlets 14 on the nozzle plate 12 as shown in FIG. 1. Furthermore, the numbers of multiple-nozzle outlets 14 can be increased according to design as long as the corresponding number of ink-jet printing modules 16 is provided. In addition, each ink-jet printing module 16 has a component part 18 that can be aligned and attached to each multiple nozzle outlet 14. Each ink-jet printing module 16 also has component parts 20 bonded to a set of conductive wires 22 for connecting with various signal-receiving points 24. Through these signal-receiving points 24, controlling signals can be transmitted to the ink-jet print-head assembly. Finally, the whole ink-jet print-head assembly 10 containing the attached, wire bonded ink-jet printing modules together with the nozzle plate 12 is mounted onto a supporting base (not shown in FIG. 1). The ink-jet printings modules 16 can be driven by a thermal bubble mechanism or a piezoelectric mechanism. Therefore, the normally available types of ink-jet drive can be incorporated into a variety of print-head designs.

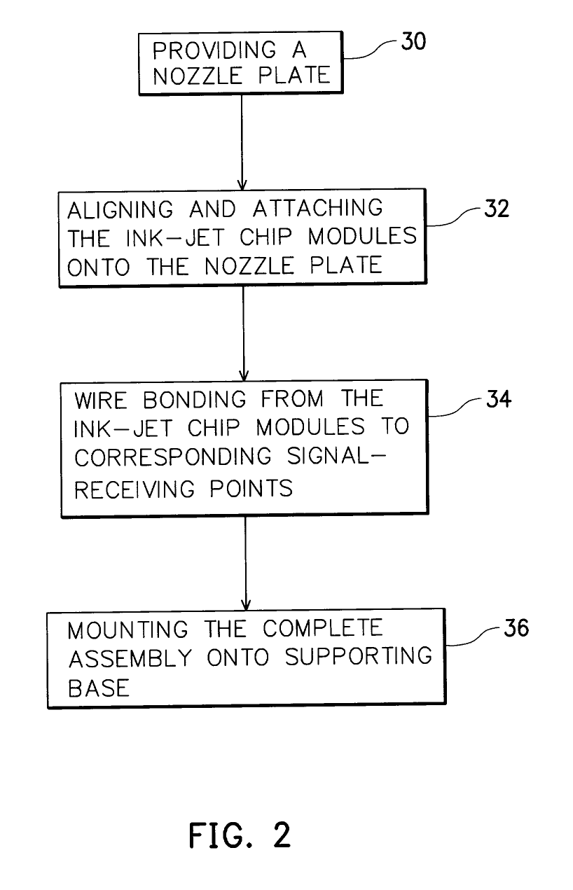

FIGS. 2 is a block diagram showing, the manufacturing steps in fabricating a high-density ink-jet print head according to the embodiment of this invention. As shown in FIG. 1, the method of fabricating a high-density ink-jet print head assembly comprises the following steps. First, a high-density wide body nozzle plate 30 is provided, where the nozzle plate contains a plurality of multiple-nozzle outlets. Next, a corresponding number of ink-jet printing modules are aligned and attached to the multiple-nozzle outlets of the nozzle plate 32. Thereafter, wires are bonded from each ink-jet printing module to corresponding signal-receiving points 34. Finally, the whole ink-jet print-head assembly containing the attached, wire bonded ink-jet printing modules together with the nozzle plate is mounted onto a supporting base 36.

As a summary, the high-density ink-jet print head assembly provided by this invention differs from a convention in several aspects, including:

(1) The conventional technique follows a modular packaging design. Each ink-jet print head component is first aligned and packaged, then a plurality of these ink-jet print head modules are combined together into one large wide body print head. Hence, the fabricating, steps are complicated and good alignment accuracy is difficult to get without highly accurate measuring equipment. Therefore, the cost of production is increased

(2) The high-density, wide body, ink-jet print head is similar in size to the one fabricated by a conventional method. The nozzle plate is fabricated using conventional electrochemical machining or laser machining operations. By aligning the ink-jet printings modules will the multiple-nozzle outlets of the nozzle plate one by one, alignment of each ink-jet printing nodules to each multiple-nozzle outlet and the alignment of the multiple-nozzle outlets themselves are combined into one operation. Hence, alignment procedures are much simplified, and cost of production can be greatly reduced.

It still be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a high-density ink-jet print head, comprising:
providing a nozzle plate having a plurality of multiple-nozzle outlets formed thereon,
aligning and attaching an ink-jet printing module onto each multiple-nozzle outlet of the nozzle plate;
wire bonding from each ink-jet printing module to the corresponding signal-receiving points, and
mounting the whole ink-jet print-head assembly containing the attached, wire bonded ink-jet printing modules together with the nozzle plate onto a supporting base.

2. The method of claim 1, wherein the nozzle plate is made of metal and fabricated using electrochemical machining operation.

3. The method of claim 1, wherein the nozzle plate is made of plastic and fabricated using laser machining, operation.

4. The method of claim 1, wherein the ink-jet is produced by the ink-jet printing module using a thermal bubble mechanism.

5. The method of claim 1, wherein the ink-jet is produced by the ink-jet printing module using a piezoelectric mechanism.

6. A high-density ink-jet print-head assembly, comprising,
a nozzle plate having a plurality of multiple-nozzle outlets formed thereon,
a plurality of ink-jet printing modules respectively aligned and attached to the multiple-nozzle outlets of the nozzle plate, and
a plurality of conductive wires with one end connected to receiving points and the other end bonded to a corresponding ink-jet printing module.

7. The assembly of claim 6, wherein the nozzle plate is made of metal and fabricated using electrochemical machining operation.

8. The assembly of claim 6, wherein the nozzle plate is made of plastic and fabricated using laser machining operation.

9. The assembly of claim 6, wherein the ink-jet is produced by the ink-jet printing module using a thermal bubble mechanism.

10. The assembly of claim 6, wherein the ink-jet is produced by the ink-jet printing module using a piezoelectric mechanism.
